(19) United States
(12) Patent Application Publication
(10) Pub. No.: US 2010/0177042 A1
(43) Pub. Date: Jul. 15, 2010

(54) Method for aiding control of cursor movement through a trackpad

(76) Inventor: Stephen Chen, Shengang Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,696

(22) Filed: Mar. 23, 2009

(30) Foreign Application Priority Data
Jan. 9, 2009 (TW) 098100766

(51) Int. Cl. G09G 5/08

(52) U.S. Cl. 345/159

(57) ABSTRACT

A method for aiding control of cursor movement through a trackpad includes a step of detecting finger touch conditions on the trackpad to control operation modes for cursor movement on a screen. The finger touch conditions are set at least in a first condition and a second condition. In the first condition the trackpad is touched by one finger, and the cursor movement on the screen is controlled in a relative movement operation mode. It the second condition the trackpad is touched in fashions other than the first condition (such as touching the trackpad with two fingers or depressing the trackpad with a selected force), and the cursor movement on the screen is controlled in an automatic movement operation mode. Through the method of the invention the cursor on the screen can be quickly moved to a targeted position without overtaxing user's fingers.

### BACKGROUND OF THE INVENTION

1. Field of the Invention

The present invention relates to a method for aiding control of cursor movement through a trackpad to quickly move a cursor on a screen to a targeted position without overtaxing user's fingers.

2. Description of the Prior Art

There are a wide variety of cursor control means available at present. Among them, mouse is most commonly used. However, on notebook computers, the mouse cannot be directly adopted due to size constraint. Hence notebook computers generally have a trackpad to provide mouse function. But the trackpad also has a size constraint. Moving a cursor for a long distance on a screen, such as from the leftmost side to the rightmost side of the screen, user's finger has to move repeatedly many times on the trackpad. By increasing the ratio of the finger movement speed and cursor movement speed on the screen, a smaller finger moving distance can control a greater moving distance of the cursor. Then one sliding of the finger can move the cursor to a targeted position. But a slight shaking of the finger also generates a greater cursor movement. To accurately pinpoint a small icon becomes difficult.

To remedy the aforesaid problem, a dynamic variable speed mechanism has been developed for the trackpad. Adopted such a mechanism, when the finger movement speed is slower the system moves the cursor at a smaller movement ratio. When the finger movement speed is faster the system also moves the cursor at a greater ratio, hence the cursor can be moved for a longer distance faster. To pinpoint a targeted icon, the finger movement speed can be slowed down and the cursor movement speed also is slower. Such an approach can mitigate the drawback of repeatedly finger movements on the trackpad mentioned above. But when the finger is moved very fast, the cursor is moved even faster. User's visual monitoring of the cursor movement is difficult, and adjustment of cursor moving direction and position during cursor movement is not easy. Moreover, moving the finger rapidly and stop moving instantly is a stressful operation to many users. Hence its practicality suffers.

Because of the aforesaid concerns, although most notebook computers have provided a trackpad, many users still prefer to have an additional external mouse and try to shut down the trackpad function when in use.

References of related techniques are discussed below:

Taiwan patent application No. 94121990 discloses a method to control movement through an intelligent touch panel. It includes detecting the position of an object on the touch panel; sending a position information of the object when the object is moved; and sending a movement signal when the object has been moved and stopped for a duration over a reference time. U.S. Pat. No. 5,543,590 entitled “Object position detector with edge motion feature” provides an intelligent automatic edge scrolling function. When a user's finger slides to an edge zone a cursor rolling signal is issued. However, it has a drawback, namely it cannot judge whether the user intends to make an ordinary cursor motion or intelligent automatic edge scrolling. Hence mistaken signals could be issued. For instance, the user could intend to perform cursor track movement, but the finger incidentally slides in the zone during movement, then the touch panel sends a scrolling signal and results in change of the track of cursor movement.

Taiwan patent publication No. 94135247 discloses a method to generate different moving speeds of window. It includes: detecting an object sliding on a touch panel; calculating the coordinate of the object on the touch panel to generate a position information; calculating the size of the object on the touch panel to generate a speed information; and generating a movement signal based on the position information and speed information to move the window.

Taiwan patent application No. 94105391 discloses a method for setting mouse parameters through different button sets. The method includes procedures as follow:

A. Providing a mouse device which has a memory and a plurality of buttons. The memory stores a mouse parameter and a composite button table which contains parameter setting modes of different button combinations;

B. Detecting whether the buttons are depressed within a selected duration during mouse operation;

C. Comparing whether the combination of the depressed buttons matches one of the button combinations on the composite button table, and proceeding a selected step when the match occurs; and

D. Setting the mouse parameter of the mouse device based on the composite button table according to a parameter setting mode corresponding to the button combination. This reference adjusts mouse movement speed through different buttons.

Taiwan Patent application No. 95137203 discloses a method for picture scrolling in a window system. The window system has an automatic scrolling unit. The picture scrolling method includes procedures: first, providing a first induction unit located in a mouse; next, judging whether the first induction unit is triggered; then activating the automatic scrolling unit; transmitting a movement signal to the window system; scrolling a picture by the automatic scrolling unit according to the movement signal; and setting off the automatic scrolling unit. It activates automatic picture scrolling through the induction unit.

Taiwan patent application No. 93208043 discloses an advance mouse which includes a mouse serving as a computer peripheral device and a multi-function modular key. Through a virtual composite key code mapping the multi-function modular key users can execute a designated function or retrieve an application software without memorizing the composite key, or adding a USB HUB or relying on a complex application or special driver. Hence it can provide plug and play function.

Taiwan patent application No. 92220855 discloses a portable presentation device which provides a presentation software operable in a window operating system through a wireless communication approach, or an operating device equipped with multimedia playing function. The operating device has a wireless remote controller and a receiver installed on a computer. The remote controller has a cursor control button with four keys operable in eight directions that can change movement speed of the cursor in the window operating system in a user operation mode. It also has a command key equivalent to a mouse button and a laser pointer function. Users can get all functions needed when making presentation through the presentation software.

Taiwan patent publication No. 93117921 discloses a fast input device to process input information of selected commands from a personal computer without overtaxing the processing power. The input device consists of a keyboard and a mouse and generates command information for cursor movement and the like. It can automatically select an active personal computer to deliver output. Based on the command information a local coordinate can be calculated and displayed on a monitor. Based on the local coordinate a global information can be derived. And based on the global information picture display on a corresponding display domain of the monitor can be controlled.

### SUMMARY OF THE INVENTION

All the aforesaid references provide various techniques to control cursor movement on the screen. But they still have problems in practice. For instance, to quickly move the cursor to a target position on the screen without overtaxing user's finger is difficult. Therefore, the present invention aims to provide a method for aiding control of cursor movement through a trackpad to quickly move a cursor on a screen to a targeted position. The method of the invention includes at least the following steps:
1. detecting touch of a finger on a trackpad, and setting at least a first condition and a second condition according touch conditions;
2. in the first condition, a coordinate alteration vector of finger movement on the trackpad being transformed to a screen cursor movement vector in a relative movement operation mode to drive cursor movement;
3. calculating latest cursor moving direction;
4. in the second condition and the finger remained still over a time set value, driving the cursor on the screen along the latest moving direction in an automatic movement operation mode; and
5. in the second condition and the cursor automatic movement operation mode, detecting whether change occurs to the finger touch conditions, and terminating the automatic movement operation mode if change is detected.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is schematic view-1 of a first embodiment of the invention.

FIG. 2 is schematic view-2 of the first embodiment of the invention.

FIG. 3 is schematic view-1 of a second embodiment of the invention.

FIG. 4 is schematic view-2 of the second embodiment of the invention.

FIG. 5 is a schematic view of the procedures of the control method of the invention.

FIG. 6-1 is the flow chart of an embodiment of the invention.

FIG. 6-2 is the flow chart of an embodiment of the invention.

FIG. 7 is a schematic view of the invention showing finger movements and corresponding cursor reactions.

### DESCRIPTION OF THE PREFERRED EMBODIMENTS

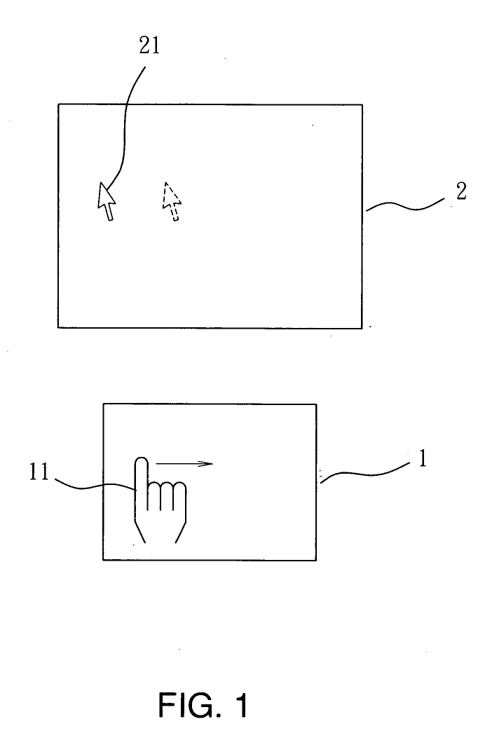

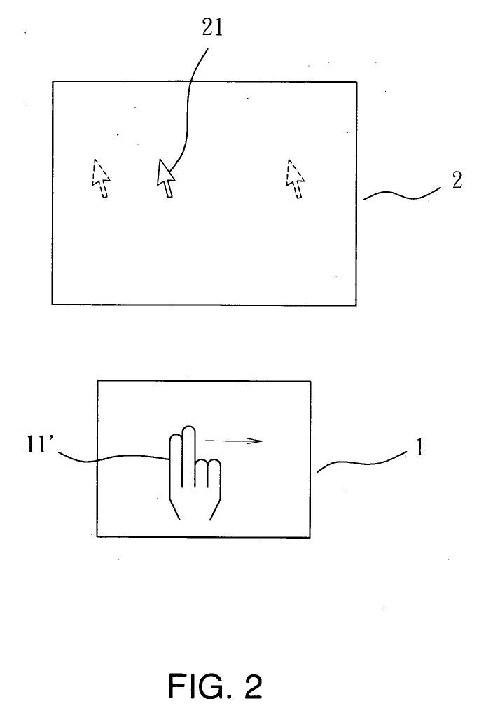

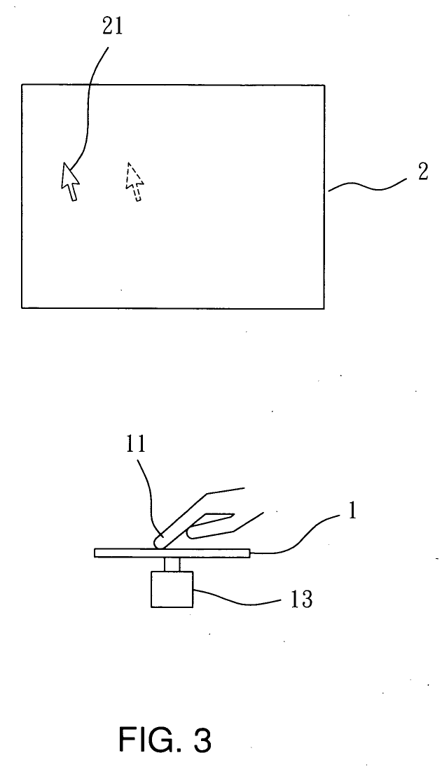

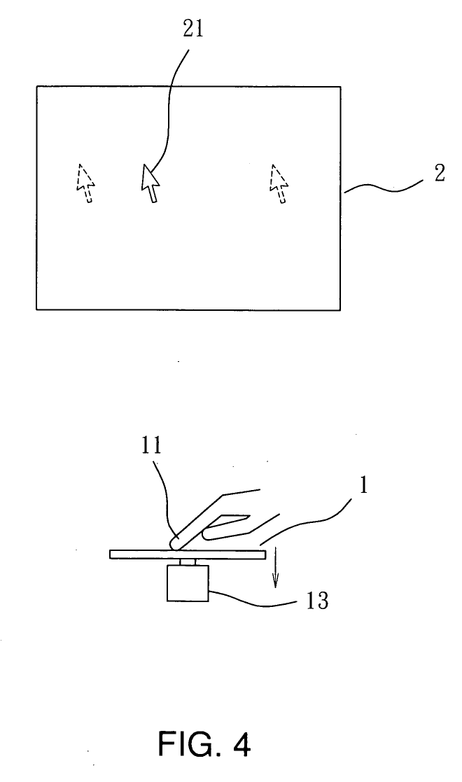

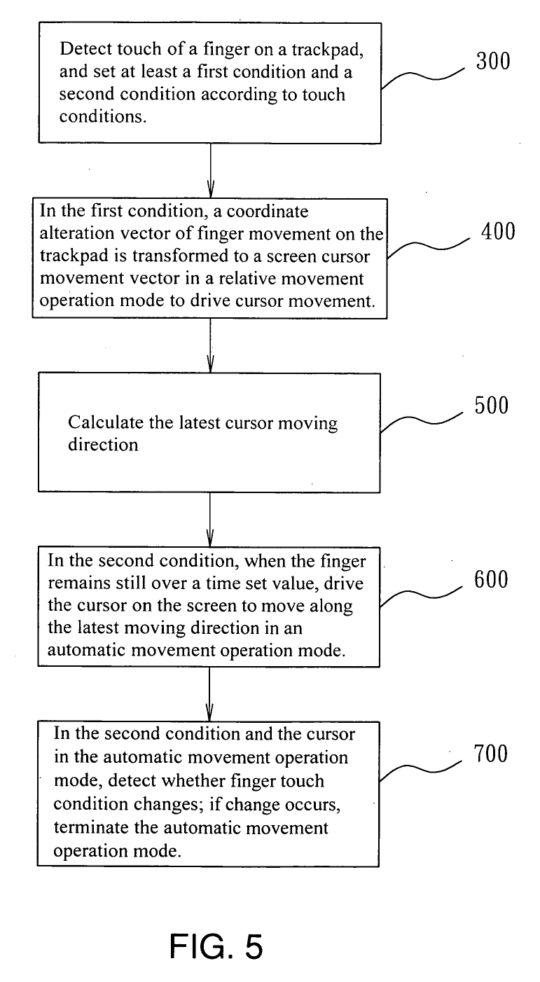

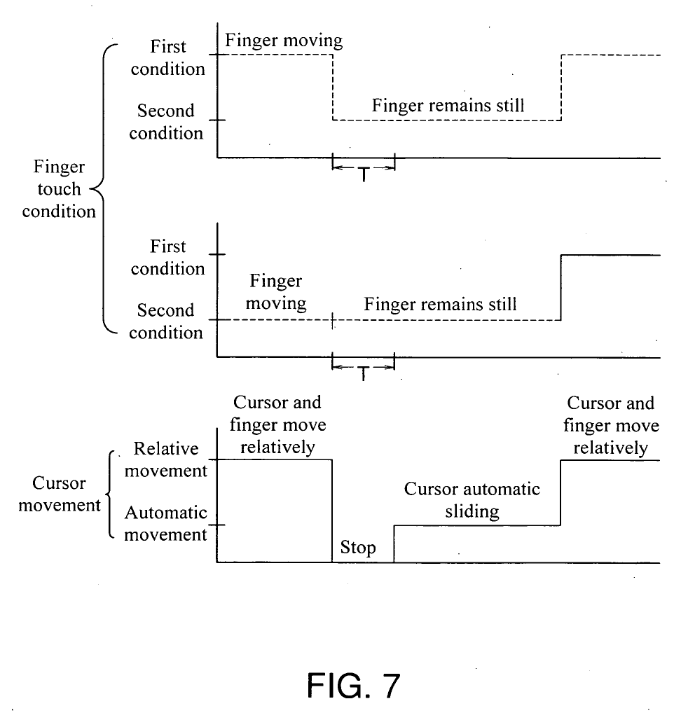

Referring to FIGS. 1 through 4, the method according to the invention is implemented through at least a trackpad 1 and a screen 2 having a cursor 21 displayed thereon. The screen 2 is a display of a conventional notebook computer. The trackpad 1 can detect touch positions and moving directions of a user's finger 11. FIGS. 1 and 2 illustrate an embodiment which has different touch conditions of the trackpad 1 by one finger 11 and two fingers 11′ in different operation modes to control cursor movement on the screen 2. FIGS. 3 and 4 illustrate another embodiment which has different touch conditions by touching the finger 11 on the trackpad 1 (referring to FIG. 3) and depressing the trackpad 1 with the finger 11 (referring to FIG. 4) in different operation modes to control cursor movement on the screen 2 (in this embodiment the trackpad 1 is a touch pad movable up and down with a button switch 13 located thereunder. When the finger 11 depresses the trackpad 1 with a force greater than the depressible force of the button switch 13 the button switch 13 is in an ON condition. If the touch force of the finger 11 on the trackpad 1 is smaller than the depressible force of the button switch 13, it is in an OFF condition. Moreover, the invention provides at least two operation modes to control cursor movement on the screen 2 through the finger 11 operating on the trackpad 1. One is relative movement operation mode, and another is automatic movement operation mode. The method for aiding control of cursor movement through a trackpad of the invention is implemented in the aforesaid operation modes. The method includes at least the following steps (referring to FIGS. 5 and 7):
1. Detect touch of a finger on a trackpad, and set at least a first condition and a second condition according to touch conditions (step 300): The trackpad 1 detects touch of the finger 11. Set the first condition and the second condition according to the touch conditions. The first condition is a regular touch of one finger 11 on the trackpad 1. The second condition is touch conditions on the trackpad other than the first condition;
2. In the first condition, a coordinate alteration vector formed by movement of the finger on the trackpad is transformed to a screen cursor movement vector in a relative movement operation mode to drive cursor movement (step 400): When the trackpad 1 is in the first condition gets a coordinate alteration vector of movement of the finger 11 in a relative operation mode and transforms to a movement vector of the cursor 21 on the screen 2 to drive cursor movement;
3. Calculate latest cursor moving direction (step 500): Calculate the movement vector of the cursor 21 at step 400 (namely the coordinate alteration vector of the finger movement) to get the latest cursor moving direction;
4. In the second condition, when the finger remains still over a time set value, drive the cursor on the screen along the latest moving direction in an automatic movement operation mode (step 600): When the trackpad 1 is in the second condition and the finger remains still for a duration exceeding a time set value T, drives the cursor 21 to move along the latest moving direction in the automatic movement operation mode (the cursor 21 movement speed accelerates from a lower speed to a faster speed); otherwise return to step 300; and
5. In the second condition and the cursor automatic movement operation mode, detect whether the finger touch condition changes; if a change happens, terminate the automatic movement operation mode (step 700).

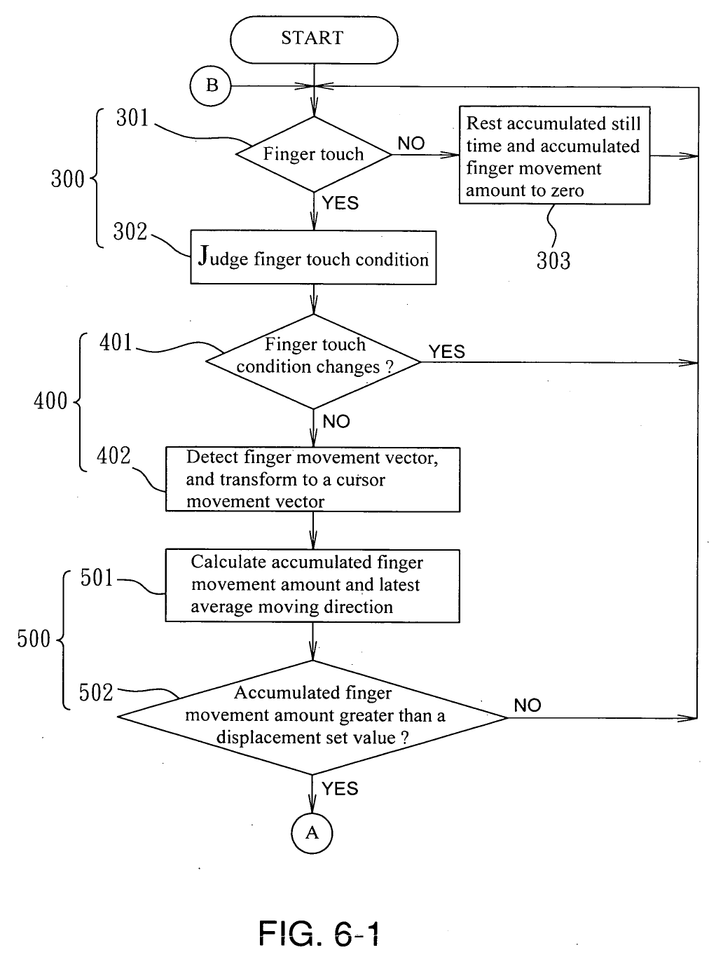

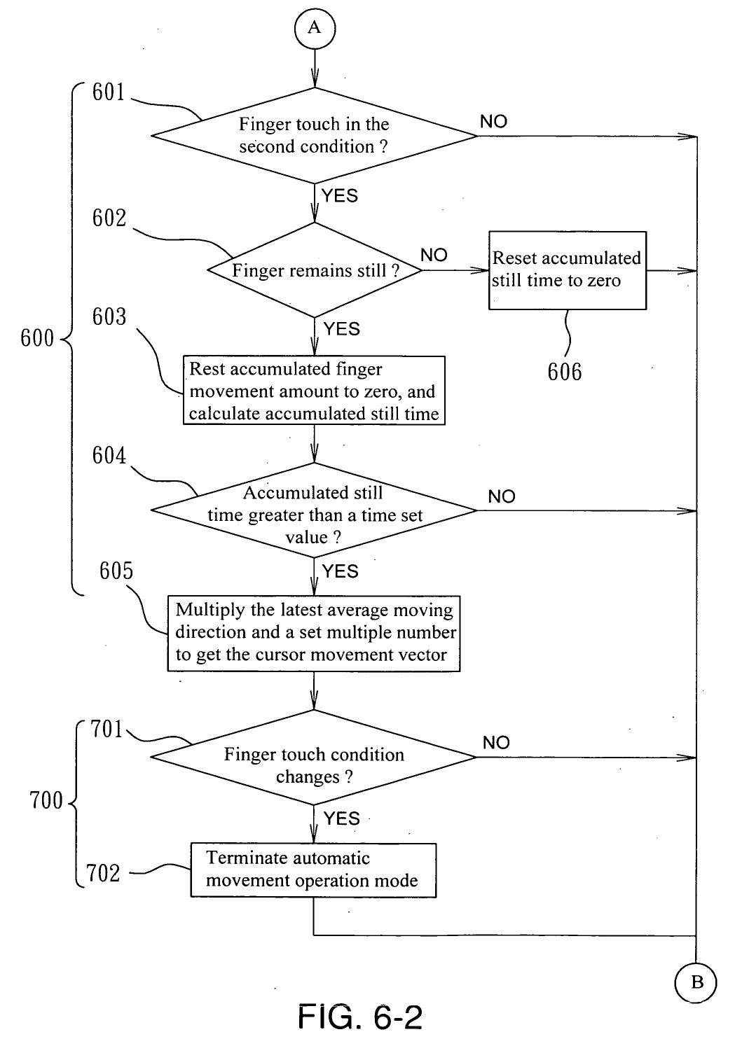

As previously discussed, the method of the invention controls movement of the cursor 21 on the screen 2 through different touch conditions of the finger on the trackpad 1. FIGS. 1 and 2 illustrate an embodiment with one finger 11 touching the trackpad 1 set as the first condition, and two fingers 11′ touching the trackpad 2 set as the second condition. FIG. 6 shows the process flow of this embodiment (also referring to FIGS. 5 and 7). The process is elaborated as follow:
1. Detect a touch condition of a finger on a trackpad, and set at least a first condition and a second condition (step 300): When a finger 11 or 11′ touches the trackpad 1 (step 301), according to touch conditions set the first condition or second condition (step 302); if the finger 11 or 11′ does not touch the trackpad 1, reset accumulated still time T1 and accumulated finger movement amount M1 to zero (namely T1=0, M1=0, steps 301 and 303);
2. In the first condition, a coordinate alteration vector formed by finger movement on the trackpad is transformed to a screen cursor movement vector in a relative movement operation mode to drive cursor movement (step 400): When the finger 11 or 11′ remains in the touch condition unchanged, detect a movement vector of the finger 11 or 11′ and transform to a movement vector of the cursor 21 on the screen 2 in the relative movement operation mode to drive cursor movement (steps 401 and 402); when the touch condition of the finger 11 or 11′ changes, return to step 300;
3. Calculate latest cursor moving direction (step 500): Calculate accumulated finger movement amount M1 and latest average moving direction (step 501); when the accumulated finger movement amount M1 is greater than a displacement set value M (M1>M), continue execution of step 600; otherwise return to step 300 (step 502);
4. In the second condition, when the finger remains still over a time set value, drive the cursor on the screen along the latest moving direction in an automatic movement operation mode (step 600): When the two fingers 11′ touch the trackpad 1, enter the second condition (step 601; if touched finger is not two fingers, return to step 300); and judge whether the fingers 11′ remain still (step 602); if a non-still condition is detected, reset the accumulated still time to zero (step 606) and return to step 300; if the fingers 11′ are still (namely finger movement amount≈0), reset accumulated finger movement amount M1 to zero (namely M1=0), and start calculating accumulated still time T1 (step 603); when the accumulated still time T1 is greater than a time set value T1, execute step 605 (otherwise return to step 300); meanwhile the cursor movement vector is derived by multiplying the latest average moving direction and a set multiple number N; and
5. In the second condition and the cursor automatic movement operation mode, detect whether the finger touch condition changes; if a change happens, terminate the automatic movement operation mode (step 700): In the second condition the cursor 21 moves in the automatic movement operation mode. When it is detected that the original two fingers 11′ touch condition changes to one finger 11 touch condition, terminate the automatic movement operation mode (steps 701 and 702). If no change detected, return to step 300.

Refer to FIGS. 3 and 4 for another embodiment in a different operating condition in which a trackpad 1 is depressed by a finger 11 to control movement of a cursor 21 on a screen 2. A first condition is set when the finger 11 touches the trackpad 1, and a second condition is set when a button switch 13 located beneath the trackpad 1 is depressed by the finger 11. Depending on whether the force depressed by the finger 11 on the trackpad 1 has reached a set value F, the button switch 13 can be opened or closed to enter the first condition or second condition based on which control is made. Refer to FIG. 6-1 and FIG. 6-2 for an embodiment of the process (also referring to FIGS. 5 and 7). The process is elaborated as follow:
1. Detect a touch condition of a finger on a trackpad, and set at least a first condition and a second condition (step 300): When the finger 11 touches the trackpad 1 (step 301), according to the touch condition set the first condition; when the button switch 13 is depressed, set the second condition (step 302); if the finger 11 does not touch the trackpad 1, rest accumulated still time T1 and accumulated finger movement amount M1 to zero (namely T1=0, M1=0, steps 301 and 303);
2. In the first condition, a coordinate alteration vector formed by finger movement on the trackpad is transformed to a screen cursor movement vector in a relative movement operation mode to drive cursor movement (step 400): When the finger 11 remains in the touch condition unchanged, detect a movement vector of the finger 11 and transform to a movement vector of the cursor 21 on the screen 2 in the relative movement operation mode to drive cursor movement (steps 401 and 402); when the touch condition of the finger 11 changes, return to step 300;
3. Calculate latest cursor moving direction (step 500): Calculate accumulated finger movement amount M1 and latest average moving direction (step 501); when the accumulated finger movement amount M1 is greater than a displacement set value M (M1>M), continue execution of step 600; otherwise return to step 300 (step 502);
4. In the second condition, when the finger remains still over a time set value, drive the cursor on the screen along the latest moving direction in an automatic movement operation mode (step 600): When the finger 11 touches the trackpad 1 and the second condition exists (step 601; if finger depressing does not occur, return to step 300), judge whether the finger 11 remains still (step 602); if a non-still condition of the finger is detected, reset the accumulated still time to zero (step 606) and return to step 300; if the finger 11 is still (namely finger movement amount≈0), reset the accumulated finger movement amount M1 to zero (namely M1=0), and start calculating accumulated still time T1 (step 603); when the accumulated still time T1 is greater than a time set value T1, execute step 605 (otherwise return to step 300); meanwhile the cursor movement vector is moved by a value derived by multiplying the latest average moving direction and a set multiple number N; and
5. In the second condition and the cursor automatic movement operation mode, detect whether the finger touch condition changes; if a change happens, terminate the automatic movement operation mode (step 700): In the second condition the cursor 21 moves in the automatic movement operation mode. When change from finger depressing to finger touching of the trackpad 1 is detected, terminate the automatic movement operation mode (steps 701 and 702). If no change detected, return to step 300.

I claim:

1. A method for aiding control of cursor movement through a trackpad, comprising at least the steps of:
detecting touch of a finger on the trackpad and setting at least a first condition and a second condition according to touch conditions;
sliding the finger on the trackpad to generate a coordinate alteration vector in the first condition and transforming the coordinate alteration vector to a screen cursor movement vector in a relative movement operation mode to drive a cursor to move;
calculating a latest cursor moving direction;
driving the cursor on a screen to move along the latest moving direction in the second condition when the finger remains still over a time set value in an automatic movement operation mode; and
detecting whether a change occurs to the finger touch conditions in the second condition and the automatic movement operation mode and terminating the automatic movement operation mode when the change occurs.

2. The method of claim 1, wherein the first condition is the trackpad touched by one finger.

3. The method of claim 1, wherein the second condition is the trackpad touched in fashions other than the first condition.

4. The method of claim 1, wherein the second condition is the trackpad touched by two fingers.

5. The method of claim 1, wherein the second condition is the finger depressing the trackpad with a force reaching a set value.

6. The method of claim 1 further having a button switch which is located beneath the trackpad and depressible by the finger to be opened or closed to control setting of the first condition and the second condition.

7. The method of claim 1, wherein the cursor moved in the first condition is controlled in the relative movement operation mode.

8. The method of claim 1, wherein the cursor moved in the second condition is controlled in the automatic movement operation mode.

9. The method of claim 1, wherein in the automatic movement operation mode the cursor is moved from a slower speed to a faster speed.
